(19) United States
(12) Patent Application Publication
(10) Pub. No.: US 2016/0018018 A1
(43) Pub. Date: Jan. 21, 2016

(54) Linear Flow Valve Assembly

(71) Applicant: John Richard Blichmann, Lafayette, IN (US)

(72) Inventor: John Richard Blichmann, Lafayette, IN (US)

(21) Appl. No.: 14/804,357

(22) Filed: Jul. 21, 2015

Related U.S. Application Data
(60) Provisional application No. 62/026,764, filed on Jul. 21, 2014.

(51) Int. Cl. F16K 31/60; F16K 1/36

(52) U.S. Cl. CPC F16K 31/60; F16K 1/36

(57) ABSTRACT

A valve assembly comprising a valve stem, a valve body having an internal surface and an external surface along the valve body, and a kettle bulkhead member. The valve stem can have a parabolic end that facilitates a substantially linear fluid flow and can allow for better control of the fluid flow through the valve. The valve stem can have a o-ring that seals the liquid within the valve assembly and can also act as a detent preventing the valve stem to be accidentally removed from the flow cavity.

### CROSS-REFERENCE TO RELATED APPLICATION

This U.S. Patent Application claims priority to U.S. Provisional Application: 62/026,764 filed Jul. 21, 2014, the disclosure of which is considered part of the disclosure of this application and is hereby incorporated by reference in its entirety.

### FIELD OF THE INVENTION

This invention relates generally to a valve assembly and a kettle system that utilizes said valve assembly. Specifically, the invention relates to a valve assembly with a member configured to attach to a kettle and an infinitely variable valve member that is designed to facilitate substantially linear fluid flow therethrough. In one aspect, the valve assembly may be used during the process of brewing beer.

### BACKGROUND

It is well known in the food and beverage industry, particularly the homemade or small scale beer making industry, to utilize a stand to support one or more vessels during the processing of various beverages. In particular, it is common to use a stand to support one or more vessels in beer brewing for the all-grain beer making process (as opposed to a malt extract brewing process where only one vessel is utilized). Typically, one vessel is used for holding hot liquid, such as water (commonly known as a “hot liquor tank”), another vessel for the mash (commonly known as a “mash tun”), and a third vessel acting as a boil vessel. During different stages of the all-grain brewing process, it is necessary to move the liquid from one vessel to another.

While multiple kettle systems are common, single kettle extract systems are used in some brewing processes. In such instances, the use of a chiller during draining or a separate fermenter may be employed. In both instances, it is also necessary to remove liquids from the vessel for subsequent processing.

One existing solution utilizes a kettle bulkhead, elbow, and shaft collar design. This solution does not allow for controlled, infinitely variable linear fluid flow since typical valve assemblies utilize a ball valve or other shaped valve stem that creates highly nonlinear fluid flow.

Other existing solutions lack the ability to remove the stem from the body for easy cleaning. And—in existing solutions—valve assemblies for brewing applications lack features that designate the “fully open” position before the stem abruptly detaches from the body. Such a feature would introduce an additional safety feature that can help prevent a sudden release of hot fluid from the kettle when opening a valve that does not designate the “fully open” position before detaching from the valve body.

Other existing solutions do not comprise a collar design that allows for the valve assembly to be mounted in infinitely variable valve shoulder-to-kettle orientations.

Many other existing solutions also have design features that act as pockets or repositories where solids, fluids, or solutions, such as old beer wort, can settle and cause bacteria to grow inside the valve assembly. Existing ball gates and globe valves are examples of valve assemblies that are particularly susceptible to such conditions.

The present disclosure overcomes these limitations by disclosing a valve assembly having a substantially parabolic valve stem that facilitates a substantially linear fluid flow therethrough.

### BRIEF SUMMARY OF THE INVENTION

In one aspect, this disclosure is related to a valve assembly comprising a valve stem, a valve body having an internal surface and an external surface along the valve body, and a kettle bulkhead member. The valve stem can have a parabolic end that facilitates a substantially linear fluid flow and can allow for better control of the fluid flow through the valve.

According to another aspect, the valve stem can have an o-ring that seals the liquid within the valve assembly and can also act as a detent preventing the valve stem to be accidentally removed from the flow cavity.

According to yet another aspect, the valve assembly can be mounted at infinite outlet angles with respect to the elbow orientation related to an axis perpendicular to the kettle improves drain hose routing, prevents drain hose kinking, and facilitates proper routing of additional fittings on the valve assembly.

### BRIEF DESCRIPTION OF THE DRAWINGS

The features and advantages of this disclosure, and the manner of attaining them, will be more apparent and better understood by reference to the following descriptions of the disclosed system and process, taken in conjunction with the accompanying drawings, wherein:

FIG. 1A a cross-sectioned-perspective view of an exemplary embodiment of a linear flow valve assembly having a shaft collar in the fully closed position.

FIG. 1B a cross-sectioned-perspective view of an exemplary embodiment of a linear flow valve assembly having a shaft collar in the fully open position.

FIG. 2 is an exploded view of an exemplary embodiment of a linear flow valve assembly.

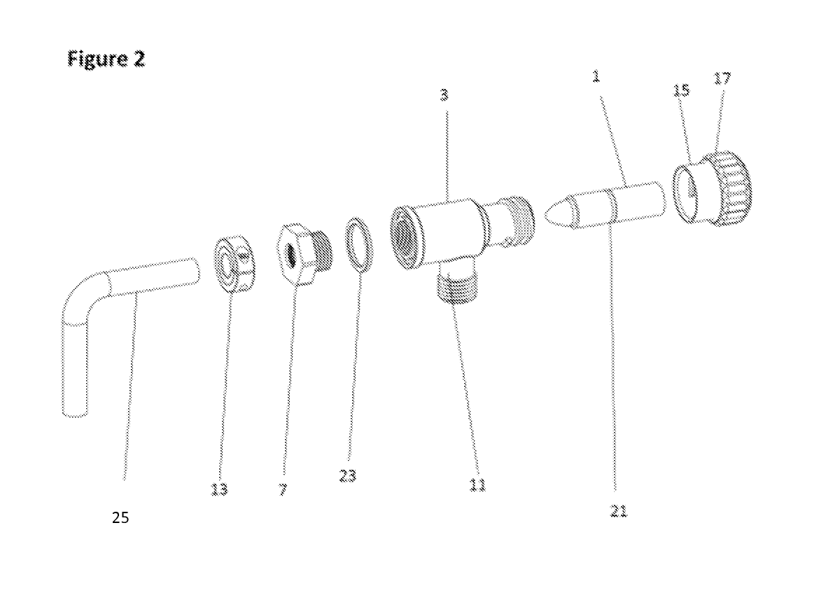

FIG. 3 is a plot of the open area versus valve stem position an exemplary embodiment of the present invention and other valve assemblies.

### DETAILED DESCRIPTION OF THE INVENTION

The present disclosure is directed to a valve assembly that provides substantially linear fluid flow therethrough while increasing the functionality of the valve assembly for use in food preparation processes, such as beer brewing, where accurate, controlled flow rate adjustment is highly useful and desired. The ability to fine tune the flow rate can be valuable for sparging, lautering, and chilling during the various brewing process. This can increase the repeatability of a brewery system and lead to more consistent batches of beer.

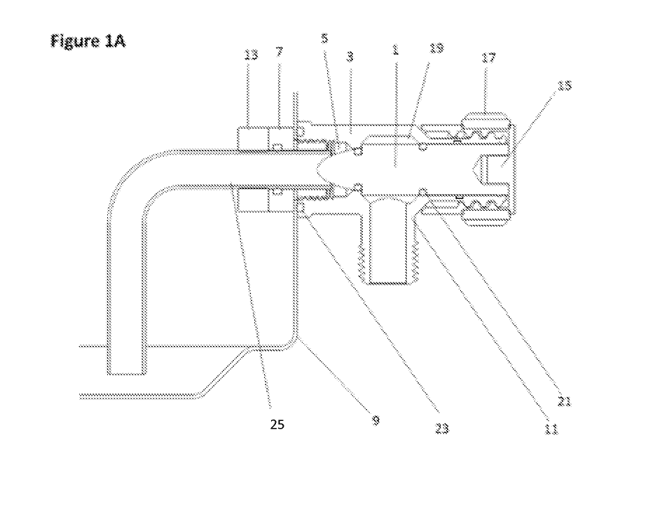

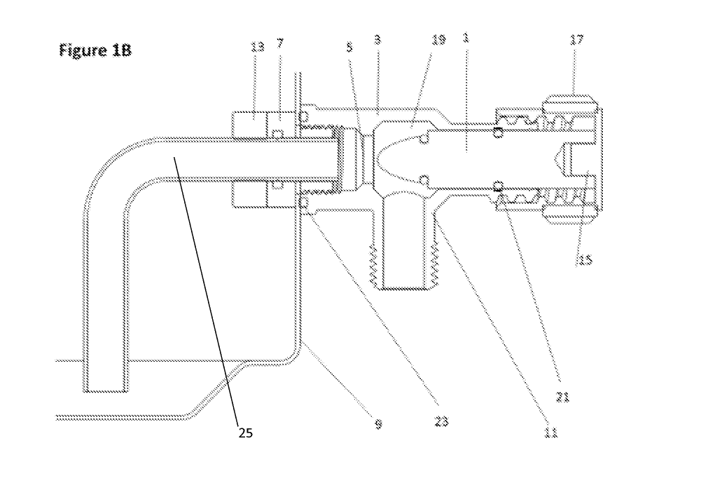

In one respect, the present disclosure, as shown in FIG. 1A can be a valve assembly having a valve stem 1 and a valve body 3 having a valve seat 5. The valve body 3 has an internal valve body surface and an external valve body surface in addition to the valve seat. The valve stem 1 and valve seat 5 are designed such that the fluid flow between them is substantially linear. The linear flow of the valve assembly allows a user to exercise better control of the flow of a liquid through the valve assembly.

In one exemplary embodiment, the valve stem 1 has a tip that is substantially parabolic in shape. The valve assembly has a kettle bulkhead 7 that is designed to engage a kettle 9. The valve assembly has an elbow 11 that is configured to facilitate the flow of liquid out of the kettle 9 to a second container via, e.g., a hose, a series of hoses, or a tee-type arrangement of outlet members. The elbow 11 may have an angle relative to the valve body 3 of between about 0° and about 180°, such as between about 30° and about 150°, such as between about 45° and about 135°, such as between about 60° and about 120°, such as between about 85° and about 95°, or such as about 90° . The variability of the outlet can be oriented at any angle to ease the routing of hoses and help ensure hoses do not kink. Additionally, this can help eliminate the need for additional elbows or other fittings on the valve that need to be cleaned after use.

The valve assembly has a shaft collar 13 proximate to the kettle bulkhead 7 that is designed to allow for the valve body 3 to engage the kettle 9 via the kettle bulkhead 7 in any rotational orientation without compromising the seal integrity between the kettle bulkhead 7 and the kettle 9. That is, the shaft collar 13 allows the elbow 11 to be oriented in any orientation within the 360° of relative positioning around an axis extending perpendicular to the body of the kettle 9. The valve assembly may have a drain tube that facilitates removal of liquid from the kettle.

The valve assembly also comprises a knob 15 with a grip 17. The knob 15 is attached to the valve stem 1. The valve assembly is designed such that as the grip 17 is rotated to move the valve stem 1 to different positions within the flow cavity 19, threads that have been incorporated into the design of the valve body 3 are visible to indicate that the valve assembly is in the full open position and no longer needs to be turned further, as depicted in FIG. 1B. The valve stem 1 may be made of any suitable material that can withstand the temperature of the brewing process and the wear of repeated use of the valve assembly. In one example, the valve stem 1 may be a stainless steel. In another example, valve stem 1 may be made out of a polymer, such as, e.g., Teflon®. Alternatively, only a portion of the valve stem 1, i.e., that portion of the valve stem 1 that engages the valve seat 5, may be made of a polymer, such as, e.g., Teflon®. In the embodiments where the valve stem 1 is made of—at least in part—with a polymer, the advantage realized is that the press seal created by the mating of the valve stem 1 and the valve seat 5 augments, or mitigates altogether, the need for sealing members, such as o-rings.

In one embodiment, the valve assembly further comprises an integrated sealing member 21 on the stem of the valve stem 1 that seals the liquid within the valve assembly, such as, e.g., an o-ring. Further, the sealing member 21 mates with a detent in the valve assembly such that as the valve stem 1 is rotated past the full-open position, where the valve stem 1 has disengaged the threads, then the sealing member 21 engages a groove feature on the internal surface of the valve body 3. Specifically, in one embodiment, the groove feature is a circumferential groove shaped like a ring to mate with an o-ring. The interaction between the sealing member 21 and the groove feature stops the travel of the valve stem 1 due to rotational force, and indicates that the valve stem 1 is at a point in the travel where the valve stem 1 can he readily removed, as detailed below. Accordingly, the valve assembly provides ongoing feedback to an operator that the valve stem 1 is at the end of travel providing several advantages, such as helping prevent unintentional fluid spills. In another example, sealing members may again be augmented or eliminated altogether if the valve assembly comprises a male or female pipe thread, such as, e.g., National Pipe Thread (NPT) or British Standard Pipe Parallel thread features.

In another embodiment, a tri-clamp type connector may be used to increase the sealing efficacy of the valve assembly. A suitable tri-clamp connector may be integrated into or connected to a rotating racking arm. In this embodiment, the valve assembly may further comprise a second elbow 11 to form a tee-type arrangement. In such a setup, a user may plug a bottom outlet of the elbow 11 and fill it with sanitizer through a top outlet, applying a plug to the top outlet as well. Doing so is highly effective at sanitizing the valve assembly and is referred to as an aeseptic valve. Such an embodiment is particularly useful in conical fermenters.

The valve assembly is designed such that once the valve stem 1 reaches the end of the travel and the detent is engaged, pulling on the grip 17 will disengage valve stem 1 from the valve body 3. In this way, the detent prevents inadvertent disengagement of the valve stem 1 from the valve body 3 at inappropriate times, such as when engaged with a kettle 9 holding high temperature fluids. Additionally, the ability to remove the valve stem 1 from the valve body 3 can facilitate thorough cleaning of the valve assembly.

The valve assembly of the present disclosure facilitates linear fluid flow therethrough, which allows for precise control of the flow of fluids. The valve assembly's substantially parabolic valve stem 1 tip increases the open area within the valve assembly in a linear fashion with respect to the turns of the flow cavity 19.

The valve assembly is able to be mounted at infinitely variable outlet angles regarding the angle of the elbow orientation relative to an axis perpendicular to the kettle. This ability improves drain hose routing, prevents drain hose kinking, and facilitates proper routing of additional fittings on the valve assembly.

The valve assembly further features a quick disconnect aspect such that the assembly is configured for rapid disengagement thereof, which includes the valve stem 1 and the knob 15 and optionally includes a grip 17. This feature facilitates efficient, thorough cleaning of the valve assembly as compared to valve assemblies known in the art, such as, e.g., ball valve assemblies.

In another aspect, the invention comprises a grip 17 made of a material, such as silicone, that acts as a thermal insulator to the high temperatures commonly encountered during the brewing process. This feature allows manual actuation of the grip when the kettle and valve assembly is in operation at high temperatures, such as about 200° C.

In another aspect, the invention comprises an integral seal 23 on the mounting end of the valve assembly. This integral seal 23 is configured to, inter alia, allow the linear valve assembly to be installed in a pot without welding. Here, a separate mating washer and retainer system is obviated by machining such features into the valve body 3. Further, the valve assembly uses a female thread on the valve body 3 while the valve assembly is mounted to the pot with a male threaded fitting for the kettle bulkhead 7. The fitting for the kettle bulkhead 7 secures the valve assembly to the pot and a dip tube 25 is connected to the valve assembly with a sealing member 21. The dip tube 25 may also have a detent in its surface for reliable engagement with the valve assembly. The shaft collar 13 can have an alignment pin that fits into a mating hole in the shaft collar 13 to properly align the shaft collar 13 with the valve assembly.

In an alternative embodiment, the valve assembly disclosed herein is not a standalone valve assembly; rather, it is integrated into a pump housing (not shown). By integrating the valve assembly into a pump housing, discrete separate fittings and hoses are not required.

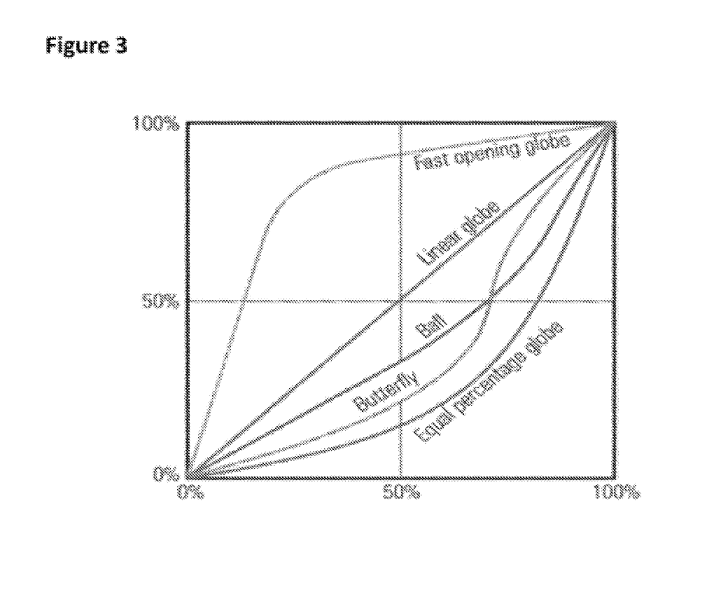

FIG. 3 is a graph showing the percent of full flow with respect to the percent open of a valve position of different valve assemblies and an exemplary embodiment of a linear flow valve assembly of the present invention. A valve can function to start or stop the flow of a liquid, as well as regulate the flow or movement of a liquid through the valve assembly. FIG. 3 demonstrates the ease of adjustability and control regarding the flow of the fluid with respect to opening the valve using the valve assembly of the current disclosure. While traditional ball valves are economical and durable for on/off application, they are not ideal for flow control of a fluid when precise flow parameters are critical to a process, such as brewing. The linear flow valve assembly of the present invention is ideal for application where such precise flow control is desired in addition to on/off operation.

It will be readily apparent to those skilled in the art that still further changes and modifications in the actual concepts described herein can readily be made without departing from the spirit and scope of the invention as defined by the following claims.

What is claimed is:

1. A valve assembly comprising:
a valve stem with a sealing member; and
a valve body having an internal valve body surface and an external valve body surface and a valve seat, the internal valve body surface having a groove configured to mate with the valve stem's sealing member;
wherein the valve stem and valve seat are configured to facilitate substantially linear fluid flow through a flow cavity as the distance between the valve stem and valve seat varies.

2. The valve assembly of claim 1 further comprising a knob affixed to the valve stem.

3. The valve assembly of claim 2 further comprising a grip affixed to the knob.

4. The valve assembly of claim 1 wherein the valve stem is substantially parabolic in shape.

5. The valve assembly of claim 4 wherein the valve stem is made of a polymer.

6. The valve assembly of claim 4 wherein the end of the valve stem that engages the valve seat is made of a polymer material.

7. The valve assembly of claim 1 further comprising a valve shaft collar.

8. The valve assembly of claim 1 further comprising a kettle bulkhead member.

9. The valve assembly of claim 1 further comprising an integrated seal near a mounting end.

10. The valve assembly of claim 1 wherein the valve body has a threaded portion that interfaces with the knob.

11. The valve assembly of claim 1 wherein the groove is circumferential.

12. The valve assembly of claim 1 wherein the sealing member is an o-ring.

13. The valve assembly of claim 1 further comprising a tri-clamp type connector.

14. The valve assembly of claim 13 wherein the tri-clamp connector is connected to a rotating racking arm.

15. The valve assembly of claim 13 further comprising two elbows configured to facilitate the flow of liquid therethrough.

16. The valve assembly of claim 1 wherein the valve assembly is an aeseptic valve.

17. A pump housing comprising a valve assembly, the valve assembly including:
a valve stem with a sealing member; and
a valve body having an internal valve body surface and an external valve body surface and a valve seat, the internal valve body surface having a groove configured to mate with the valve stem's sealing member;
wherein the valve stem and valve seat are configured to facilitate substantially linear fluid flow through a flow cavity as the distance between the valve stem and valve seat varies.

18. The pump housing of claim 17 wherein the valve stem is substantially parabolic in shape.

19. The pump housing of claim 17 wherein the groove is circumferential.

20. The pump housing of claim 17 wherein the valve assembly is an aeseptic valve.
